(19) United States
(12) Patent Application Publication
(10) Pub. No.: US 2025/0312944 A1
(43) Pub. Date: Oct. 9, 2025

(54) CUTTING METHOD AND MANUFACTURING METHOD FOR CHIP

(71) Applicant: DISCO CORPORATION, Tokyo (JP)

(72) Inventor: Nobuhiko Karashima, Tokyo (JP)

(21) Appl. No.: 19/093,507

(22) Filed: Mar. 28, 2025

(30) Foreign Application Priority Data
Apr. 8, 2024 (JP) 2024-061931

(51) Int. Cl. B28D 5/00; B28D 5/04

(52) U.S. Cl. CPC B28D 5/0088; B28D 5/042

(57) ABSTRACT

A cutting method for cutting a workpiece is provided. This cutting method includes holding the workpiece including a crystal structure having a c-axis inclined with respect to a perpendicular to a surface and a c-plane perpendicular to the c-axis and cutting the workpiece along a planned cutting plane that is perpendicular to the surface and is inclined with respect to the c-plane by rotating a cutting blade having an annular cutting edge and making a tip portion of the cutting edge cut into the workpiece. In the cutting the workpiece, the tip portion is made to cut into the workpiece in a state in which a force in such an orientation as to bring an angle formed by the planned cutting plane and the tip portion close to 0° acts on the cutting edge from the workpiece when the tip portion is made to cut into the workpiece.

### BACKGROUND OF THE INVENTION

### Field of the Invention

The present invention relates to a cutting method for executing cutting (cutting processing) of a workpiece including a crystal structure and a manufacturing method for a chip in which a workpiece is split by this cutting method to manufacture the chip.

### Description of the Related Art

A chip (device chip) including a power device suitable for control of power is incorporated in power electronics equipment such as an inverter. In recent years, many of these power devices have been manufactured by using a silicon carbide (SiC) wafer containing a single crystal of SiC advantageous for increase in the withstand voltage and reduction in loss (for example, refer to Japanese Patent Laid-open No. 2006-140341).

The crystal structure of SiC is a hexagonal system having six-fold symmetry, and has a c-axis as a six-fold rotation axis and a c-plane perpendicular to this c-axis. In the SiC wafer, due to a manufacturing method for this SiC wafer, in general, the c-axis is inclined with respect to a perpendicular to a surface of the SiC wafer as a surface on which the power device or the like is formed.

When the SiC wafer is divided into a plurality of chips, for example, a cutting apparatus in which a processing tool that has an annular cutting edge and is referred to as a cutting blade is mounted on a spindle is used. The cutting blade is rotated at a high speed, and the cutting edge is made to cut into the SiC wafer along a planned cutting plane (planned cutting line, street) set perpendicularly to the surface of the SiC wafer. Thereby, the SiC wafer is cut along the planned cutting plane and is divided into the plurality of chips.

### SUMMARY OF THE INVENTION

Incidentally, when the cutting edge of the cutting blade is made to cut into a workpiece mainly containing a material having a crystal structure of a trigonal system or a hexagonal system like SiC, the workpiece is sometimes cut along a plane inclined from the planned cutting plane. In this case, it becomes impossible to obtain a chip with a desired shape.

Thus, an object of the present invention is to provide a novel cutting method that can cut a workpiece along a planned cutting plane and a manufacturing method for a chip in which a workpiece is split by this cutting method to manufacture the chip.

In accordance with an aspect of the present invention, there is provided a cutting method for cutting a workpiece. The cutting method includes holding the workpiece including a crystal structure having a c-axis inclined with respect to a perpendicular to a surface and a c-plane perpendicular to the c-axis and cutting the workpiece along a planned cutting plane that is perpendicular to the surface and is inclined with respect to the c-plane by rotating a cutting blade having an annular cutting edge and making a tip portion of the cutting edge cut into the workpiece. In the cutting the workpiece, the tip portion is made to cut into the workpiece in a state in which a force in such an orientation as to bring an angle formed by the planned cutting plane and the tip portion close to 0° acts on the cutting edge from the workpiece when the tip portion is made to cut into the workpiece.

In accordance with another aspect of the present invention, there is provided a manufacturing method for a chip in which the workpiece is split by the above-described cutting method to manufacture the chip. In the cutting the workpiece, the workpiece is split along the planned cutting plane to manufacture the chip.

In the aspect and the other aspect of the present invention, in some cases, the cutting blade is configured such that the tip portion is not inclined with respect to a base end portion of the cutting edge on the side opposite to the tip portion in a state in which the cutting edge is made still without being made to cut into the workpiece, and, in the cutting the workpiece, the tip portion is made to cut into the workpiece in a state in which the base end portion is inclined from the planned cutting plane. In this case, it is preferable that, in the cutting the workpiece, the base end portion be inclined from the planned cutting plane such that the base end portion forms an angle that is larger than 0° and is smaller than an angle between the perpendicular and the c-axis with respect to the planned cutting plane.

In the aspect and the other aspect of the present invention, in some cases, the cutting blade is configured such that the tip portion is inclined with respect to a base end portion of the cutting edge on the side opposite to the tip portion in a state in which the cutting edge is made still without being made to cut into the workpiece. In this case, it is preferable that the cutting blade be configured such that the tip portion forms an angle that is larger than 0° and is smaller than an angle between the perpendicular and the c-axis with respect to the base end portion in a state in which the cutting edge is made still without being made to cut into the workpiece.

In the aspect and the other aspect of the present invention, in some cases, the cutting blade is configured such that the tip portion is not inclined with respect to a base end portion of the cutting edge on the side opposite to the tip portion in a state in which the cutting edge is made still without being made to cut into the workpiece and the tip portion is inclined with respect to the base end portion due to a force generated in association with rotation of the cutting edge in a state in which the cutting edge is rotated without being made to cut into the workpiece, and, in the cutting the workpiece, the tip portion is made to cut into the workpiece in a state in which adjustment has been executed such that at least part of the force that acts on the cutting edge from the workpiece and the force generated in association with the rotation of the cutting edge are in such orientations as to cancel out each other.

In the cutting method according to the aspect of the present invention and the manufacturing method for a chip according to the other aspect of the present invention, the tip portion is made to cut into the workpiece in the state in which the force in such an orientation as to bring the angle formed by the planned cutting plane and the tip portion close to 0° acts on the cutting edge from the workpiece when the tip portion is made to cut into the workpiece. Thus, according to the cutting method in accordance with the aspect of the present invention and the manufacturing method for a chip in accordance with the other aspect of the present invention, even with the workpiece including the crystal structure having the c-axis inclined with respect to the perpendicular to the surface, it becomes possible to cut the workpiece along the planned cutting plane perpendicular to the surface.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view depicting a cutting apparatus;

FIG. 2 is a perspective view depicting a workpiece;

FIG. 3 is a side view depicting the workpiece;

FIG. 4 is a sectional view depicting a state in which the workpiece is cut;

FIG. 5 is a sectional view depicting a state in which the workpiece is cut along a plane inclined from a planned cutting plane;

FIG. 6 is a sectional view depicting a state in which the workpiece is cut in a cutting method or the like according to the present embodiment;

FIG. 7 is a sectional view depicting a state in which the workpiece is cut in a cutting method or the like according to a first modification;

FIG. 8 is a front view depicting a state in which a cutting blade used in a cutting method or the like according to a second modification rotates; and

FIG. 9 is a sectional view depicting a state in which the workpiece is cut in the cutting method or the like according to the second modification.

### DETAILED DESCRIPTION OF THE PREFERRED EMBODIMENT

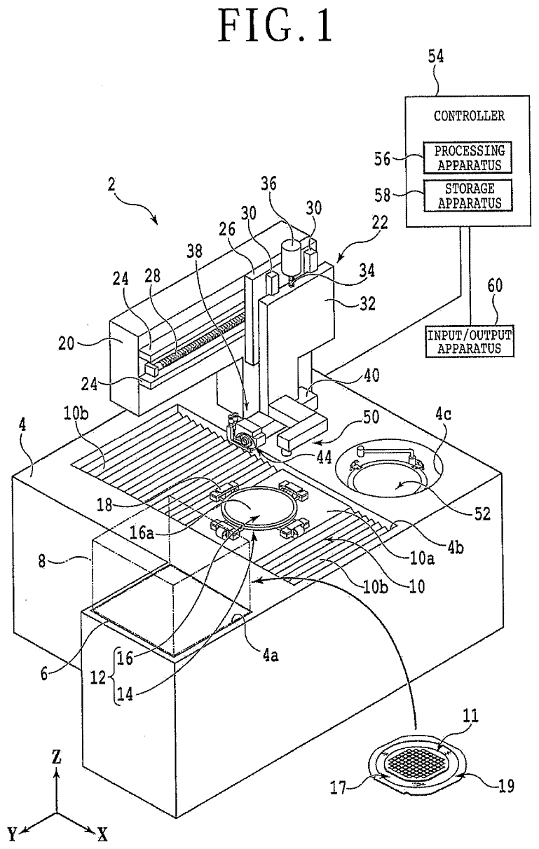

An embodiment of the present invention is described below with reference to the accompanying drawings. FIG. 1 is a perspective view depicting a cutting apparatus 2 used in a cutting method or a manufacturing method for a chip (that is, cutting method or the like) according to the present embodiment. In FIG. 1, some of constituent elements of the cutting apparatus 2 are represented by functional blocks. Further, an X-axis, a Y-axis, and a Z-axis used in the following description are perpendicular to each other.

As depicted in FIG. 1, the cutting apparatus 2 includes a base 4 that supports various constituent elements. An opening 4a is formed at a corner portion of an upper surface of the base 4. A cassette table 6 raised and lowered by a raising/lowering mechanism (not depicted) is disposed in this opening 4a. A cassette 8 that can house a plate-shaped workpiece 11 is placed on an upper surface of the cassette table 6. In FIG. 1, only contours of the cassette 8 are depicted for convenience of description.

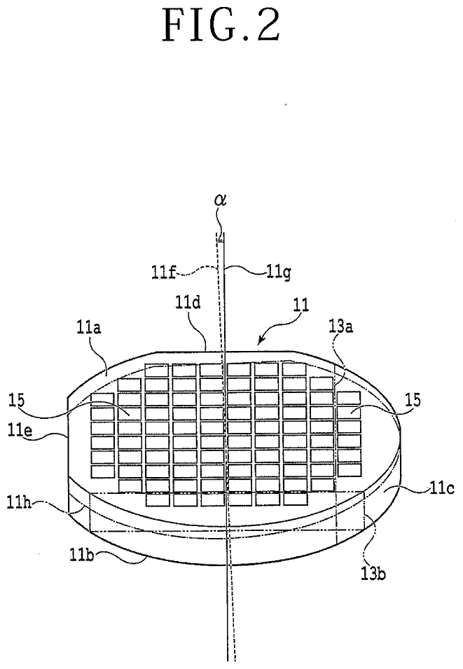

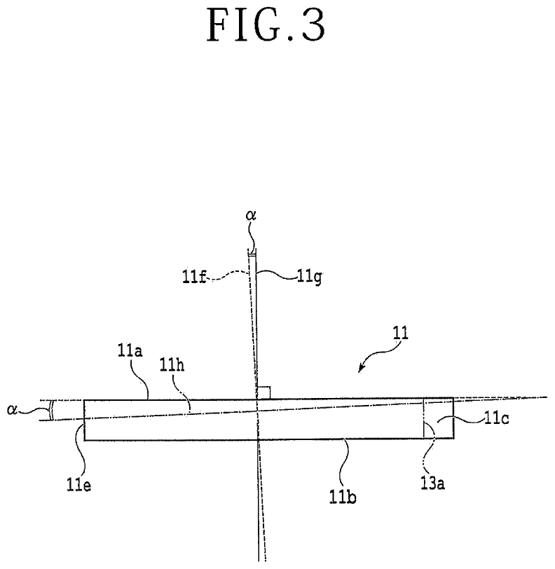

FIG. 2 is a perspective view depicting the workpiece 11 to be cut in the cutting method or the like according to the present embodiment. FIG. 3 is a side view depicting the workpiece 11. The workpiece 11 is a circular disc-shaped semiconductor wafer (SiC wafer) mainly containing a single crystal of SiC having a crystal structure of a hexagonal system. Typically, the workpiece 11 is obtained by slicing a semiconductor ingot (SiC ingot) manufactured by a sublimation recrystallization method.

As depicted in FIGS. 2 and 3, the workpiece 11 has a circular first surface 11a that is substantially flat and a circular second surface 11b that is located on the side opposite to the first surface 11a, is substantially parallel to the first surface 11a, and is substantially flat. The first surface 11a and the second surface 11b are connected to each other by a side surface 11c. At part of the side surface 11c, a first orientation flat 11d that is substantially flat and a second orientation flat 11e that is substantially perpendicular to the first orientation flat 11d and is substantially flat are formed.

The first orientation flat 11d and the second orientation flat 11e are made in conformity with the crystal orientation of the SiC forming the workpiece 11, and both have a straight line shape as viewed in a direction perpendicular to the first surface 11a and the second surface 11b. Moreover, a length of the first orientation flat 11d as viewed in the direction perpendicular to the first surface 11a and the second surface 11b is longer than a length of the second orientation flat 11e as viewed in the same direction.

In general, in a process of causing growth of a crystal based on SiC to manufacture the workpiece 11, a c-axis 11f of a single crystal of the SiC forming this workpiece 11 is inclined with respect to a perpendicular 11g to the first surface 11a and the second surface 11b. Specifically, the c-axis 11f is inclined from the perpendicular 11g by an angle of a (referred to as an off-angle or the like) in a direction toward the second orientation flat 11e. Therefore, a c-plane 11h perpendicular to the c-axis 11f also forms the angle of a with respect to the first surface 11a and the second surface 11b.

The c-plane 11h is a crystal plane or a lattice plane in a crystal structure of a hexagonal system (or a trigonal system), and is expressed as {0001} with use of the Miller index. When the workpiece 11 is a semiconductor wafer mainly containing a single crystal of SiC, a is typically 4°. However, a in this case can be freely set in a range of 1° to 6°.

The side of the first surface 11a of the workpiece 11 is segmented into a plurality of small regions by planned cutting planes (planned cutting lines, streets) 13a, planned cutting planes (planned cutting lines, streets) 13b, and the like perpendicular to the first surface 11a, and a device 15 such as a power device is formed in each small region. When the workpiece 11 configured in this manner is housed in the cassette 8, for example, as depicted in FIG. 1, a tape 17 is applied to the second surface 11b side of the workpiece 11, and an annular frame 19 is fixed to an outer edge portion of the tape 17.

Although the semiconductor wafer mainly containing the single crystal of SiC is employed as the workpiece 11 in the present embodiment, the workpiece 11 may be composed of another material having a crystal structure of a trigonal system or a hexagonal system. As a material of the trigonal system, typically, lithium tantalate (LT) is used. As another material of the hexagonal system, for example, gallium nitride (GaN) is used. α in a case in which the workpiece 11 mainly contains a single crystal of LT is, for example, 9°. α in a case in which the workpiece 11 mainly contains a single crystal of GaN is, for example, 0.5°.

The first orientation flat 11d and the second orientation flat 11e do not necessarily need to be formed in the side surface lic of the workpiece 11. Moreover, another orientation flat, a notch (cutout), or the like according to the crystal orientation may be made in the workpiece 11 instead of the first orientation flat 11d and the second orientation flat 11e or in addition to them.

The kind, quantity, shape, structure, size, arrangement, and the like of the devices 15 are also not limited to the above-described form. The devices 15 do not need to be formed on the workpiece 11. Further, the tape 17 does not necessarily need to be applied to the workpiece 11. That is, the workpiece 11 does not necessarily need to be supported by the annular frame 19 with the interposition of the tape 17.

As depicted in FIG. 1, an opening 4b elongated in a direction along the X-axis is formed at a position adjacent to the cassette table 6 in a direction along the Y-axis. A chuck table movement mechanism (processing feed mechanism) 10 of a ball screw system is disposed in the opening 4b. The chuck table movement mechanism 10 includes a rotational drive source (not depicted) such as a motor connected to an end portion of a ball screw and an X-axis moving table (not depicted) having a nut portion joined to the ball screw, and moves the X-axis moving table along the X-axis.

The upper side of the X-axis moving table is covered by a table cover 10a. Moreover, a bellows-shaped dust-proof and drip-proof cover 10b that expands and contracts in response to movement of the X-axis moving table and the table cover 10a is attached to both end portions of the table cover 10a in the direction along the X-axis. At an upper portion of the X-axis moving table, a chuck table (holding table) 12 for holding the workpiece 11 is disposed in such a manner as to be exposed from the table cover 10a.

For example, the chuck table 12 is connected to a rotational drive source (not depicted) such as a motor fixed to the X-axis moving table, and rotates around a rotation axis substantially parallel to the Z-axis. Further, the chuck table 12 moves along the X-axis together with the X-axis moving table by the above-described chuck table movement mechanism 10 (processing feed).

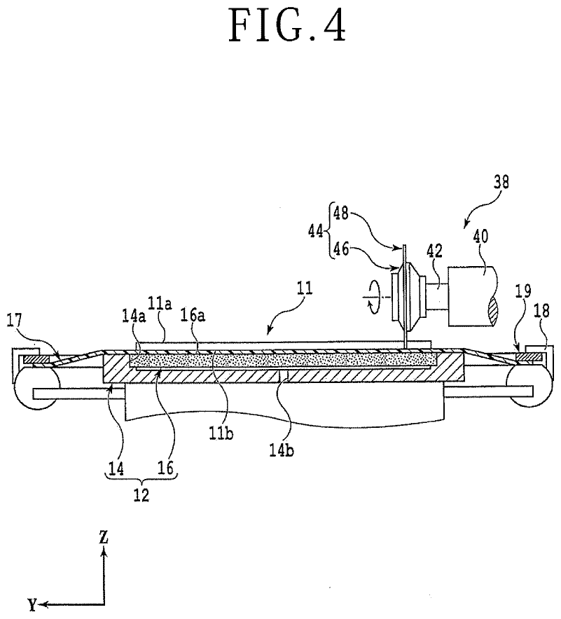

The chuck table 12 includes, for example, a circular disc-shaped frame body 14 formed of metal typified by stainless steel. On the upper surface side of the frame body 14, a recess portion 14a (see FIG. 4) made by opening the upper end into a circular shape is formed. A circular disc-shaped holding plate 16 that matches the shape of the recess portion 14a of the frame body 14 is fitted into this recess portion 14a. Four clamps 18 for fixing the annular frame 19 that supports the workpiece 11 are disposed around the frame body 14.

For example, the holding plate 16 is formed into a porous plate shape by a material such as ceramic, and holds the workpiece 11 by its upper surface (holding surface) 16a. The upper surface 16a of the holding plate 16 is configured to be substantially parallel to the X-axis and the Y-axis in a state in which the holding plate 16 is fitted into the recess portion 14a. That is, the chuck table 12 rotates around the rotation axis substantially perpendicular to the upper surface 16a of the holding plate 16.

A suction source (not depicted) is connected to the bottom of the recess portion 14a of the frame body 14 through a flow path 14b, a valve (not depicted), and the like. Thus, when the valve is opened, a negative pressure of the suction source acts on the upper surface 16a of the holding plate 16 through the flow path 14b and the like. As the suction source, for example, a vacuum pump obtained by combining a supply source of air and an ejector is used. However, another pump or the like different in the principle may be used as the suction source.

One or multiple conveying mechanisms (not depicted) that can convey the above-described workpiece 11 (annular frame 19) to the chuck table 12 and the like are disposed over the opening 4b. The workpiece 11 conveyed by the conveying mechanism is placed on the upper surface 16a of the chuck table 12 such that, for example, the first surface 11a side is exposed upward.

A cantilevered support structure 20 is disposed at a position adjacent to the opening 4b in a direction along the Y-axis. A cutting unit movement mechanism (indexing feed mechanism, cutting-in feed mechanism) 22 is disposed at an upper portion of the support structure 20. This cutting unit movement mechanism 22 has a pair of Y-axis guide rails 24 that are fixed to a front face (front surface) of the support structure 20 and are substantially parallel to the Y-axis.

A Y-axis moving plate 26 forming the cutting unit movement mechanism 22 is attached to the Y-axis guide rails 24 slidably along the Y-axis. A nut portion (not depicted) forming a ball screw is disposed on the back face side (back surface side) of the Y-axis moving plate 26. A screw shaft 28 substantially parallel to the Y-axis guide rails 24 is rotatably joined to the nut portion.

A rotational drive source (not illustrated) such as a motor is connected to one end portion of the screw shaft 28. The screw shaft 28 is rotated by the rotational drive source, and thereby the Y-axis moving plate 26 moves along the Y-axis guide rails 24. A pair of Z-axis guide rails 30 substantially parallel to the Z-axis are fixed to a front face (front surface) of the Y-axis moving plate 26. A Z-axis moving plate 32 is attached to the pair of Z-axis guide rails 30 slidably along the Z-axis.

A nut portion (not depicted) forming a ball screw is disposed on the back face side (back surface side) of the Z-axis moving plate 32. A screw shaft 34 substantially parallel to the Z-axis guide rails 30 is rotatably joined to the nut portion. A rotational drive source 36 such as a motor is connected to one end portion of the screw shaft 34. The screw shaft 34 is rotated by the rotational drive source 36, and thereby the Z-axis moving plate 32 moves along the Z-axis guide rails 30.

A cutting unit 38 is disposed at a lower portion of the Z-axis moving plate 32. The cutting unit 38 includes a spindle housing 40 formed into a cylindrical shape. A portion excluding a tip portion in a circular columnar spindle 42 (see FIG. 4 and the like) that serves as a rotating shaft parallel to or slightly inclined from the Y-axis is housed inside the spindle housing 40.

A cutting blade 44 with a circular disc shape is mounted on the tip portion of the spindle 42 exposed to the outside of the spindle housing 40. A rotational drive source (not illustrated) such as a motor is joined to a base end portion of the spindle 42. The cutting blade 44 is, for example, a generally-called hub-type cutting blade integrally including a circular disc-shaped blade base 46 (see FIG. 4 and the like) composed of metal or the like and an annular cutting edge 48 (see FIG. 4 and the like) disposed along the outer circumferential edge of the blade base 46. The cutting edge 48 is obtained by binding abrasive grains of diamond or the like by a bond of resin or the like.

A camera (imaging unit) 50 for imaging the workpiece 11 held by the chuck table 12, for example, is fixed at a position adjacent to the cutting unit 38 under the Z-axis moving plate 32. Thus, when the Y-axis moving plate 26 is moved along the Y-axis by the cutting unit movement mechanism 22, the cutting unit 38 and the camera 50 also move along the Y-axis (indexing feed). Further, when the Z-axis moving plate 32 is moved along the Z-axis by the cutting unit movement mechanism 22, the cutting unit 38 and the camera 50 also move along the Z-axis (cutting-in feed).

An opening 4c is formed at a position on the side opposite to the opening 4a across the opening 4b. A cleaning unit 52 for cleaning the workpiece 11 and the like after cutting is disposed in the opening 4c. A controller (control unit) 54 is connected to elements such as the chuck table movement mechanism 10, the conveying mechanism, the cutting unit movement mechanism 22, the cutting unit 38, the camera 50, and the cleaning unit 52.

The controller 54 is configured by, for example, a computer including a processing apparatus 56 and a storage apparatus 58, and controls operation and the like of each element of the above-described cutting apparatus 2 such that the workpiece 11 is properly cut. The processing apparatus 56 is typically a central processing unit (CPU), and executes various kinds of processing required to control the above-described elements.

The storage apparatus 58 includes, for example, a main storage apparatus such as a dynamic random access memory (DRAM) and an auxiliary storage apparatus such as a hard disk drive or a flash memory. Functions of the controller 54 are implemented by, for example, operation of the processing apparatus 56 according to software (program or the like) stored in the storage apparatus 58.

An input/output apparatus (input apparatus, output apparatus) 60 that serves as a user interface is connected to this controller 54. The input/output apparatus 60 is, for example, a touch screen, and inputs a command from an operator to the controller 54. Further, the input/output apparatus 60 outputs (in a case of the touch screen, displays) information relating to the cutting apparatus 2 on the basis of a command made by the controller 54 such that the operator can recognize the information.

Although the input/output apparatus 60 having the input function and the output function in combination is depicted in the present embodiment, an input apparatus having the input function and an output apparatus having the output function may be each connected to the controller 54. As the input apparatus, for example, a keyboard, a mouse, and the like can be employed. It is possible to employ, as the output apparatus, for example, a display apparatus such as a liquid crystal display, a speaker that can transmit information by sound, an indication lamp that can transmit information by a color of light or a state of light emission (light emission, blinking, light-off, and the like).

FIG. 4 is a sectional view depicting a state in which the workpiece 11 is cut. In FIG. 4, hatching and the like of the workpiece 11 are omitted for convenience of description. In the cutting method or the like according to the present embodiment, first, the workpiece 11 is held by the chuck table 12 (holding step). Specifically, the workpiece 11 is carried out from the cassette 8 by the conveying mechanism and the like of the cutting apparatus 2, and is placed on the chuck table 12. In the present embodiment, the workpiece 11 is placed on the chuck table 12 such that the second surface 11b is oriented toward the upper surface 16a side of the chuck table 12.

Next, the valve is opened to cause a negative pressure of the suction source to act on the upper surface 16a of the chuck table 12. Due to this, the second surface 11b side (in the present embodiment, tape 17) of the workpiece 11 is sucked by the upper surface 16a of the chuck table 12, and the workpiece 11 is held by the chuck table 12 in a state in which the first surface 11a is oriented upward. The annular frame 19 is fixed by the clamps 18 as depicted in FIG. 4.

After the workpiece 11 is held by the chuck table 12, the workpiece 11 is cut by rotating the cutting blade 44 and making part of the cutting edge 48 cut into the workpiece 11 (cutting step). Specifically, the rotational drive source connected to the chuck table 12 adjusts the orientation of the chuck table 12 around the Z-axis such that the planned cutting plane 13a, the planned cutting plane 13b, or the like that is a target of the cutting becomes substantially parallel to the X-axis.

Moreover, the chuck table movement mechanism 10 adjusts the position of the chuck table 12 along the X-axis such that at least a portion including the lowermost point in the cutting edge 48 of the cutting blade 44 does not overlap with the workpiece 11 as viewed from the upper side. Further, the cutting unit movement mechanism 22 adjusts the position of the cutting unit 38 along the Y-axis such that at least part of the cutting edge 48 of the cutting blade 44 is disposed in a plane including the planned cutting plane 13a, the planned cutting plane 13b, or the like of the target.

Thereafter, the cutting unit movement mechanism 22 adjusts the position of the cutting unit 38 along the Z-axis such that a height (position in a direction along the Z-axis) of the lowermost point in the cutting edge 48 of the cutting blade 44 becomes slightly lower than a height of the second surface 11b of the workpiece 11. Moreover, the rotational drive source of the cutting unit 38 rotates the cutting blade 44 together with the spindle 42 at the number of rotations (rotation speed) of approximately 10000 rpm to 50000 rpm.

Then, the chuck table movement mechanism 10 moves the chuck table 12 at a speed (processing feed rate) of approximately 20 mm/s to 200 mm/s to cause the cutting blade 44 to traverse the workpiece 11 along the X-axis. In addition, liquid for the cutting, typified by purified water, is supplied to the workpiece 11 and the cutting blade 44. Thereby, the workpiece 11 is cut by the cutting blade 44 along the planned cutting plane 13a, the planned cutting plane 13b, or the like of the target, and is split.

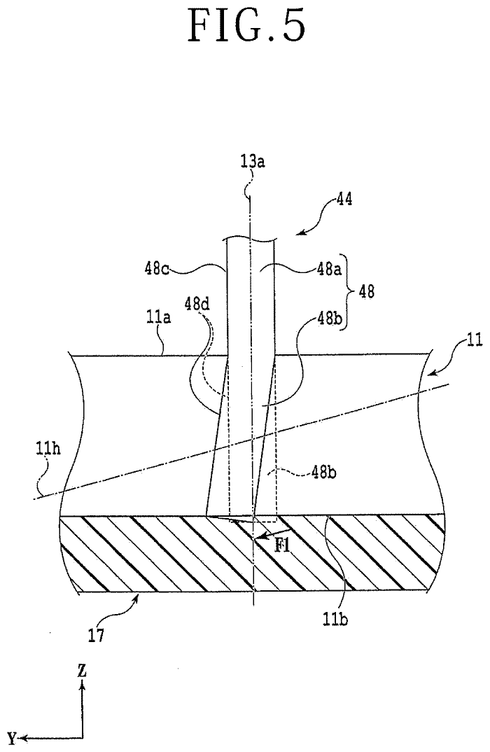

Incidentally, when cutting of the above-described workpiece 11 along the planned cutting plane 13a inclined with respect to the c-plane 11h (planned cutting plane 13a that is not perpendicular to the c-plane 11h) is attempted, the workpiece 11 is sometimes cut along a plane inclined from this planned cutting plane 13a. FIG. 5 is a sectional view depicting a state in which the workpiece 11 is cut along a plane inclined from the planned cutting plane 13a. In FIG. 5, hatching and the like of the workpiece 11 are omitted for convenience of description.

For example, in the example depicted in FIG. 5, in a state in which a base end portion 48a (portion close to the blade base 46) of the cutting edge 48 of the cutting blade 44 is parallel to the planned cutting plane 13a, a tip portion 48b (portion remote from the blade base 46) of the cutting edge 48 located on the side opposite to this base end portion 48a cuts into the workpiece 11. That is, the tip portion 48b of the cutting edge 48 cuts into the workpiece 11 such that a direction along a side surface 48c of the base end portion 48a of the cutting edge 48 (direction in which the base end portion 48a extends) is parallel to the planned cutting plane 13a.

Further, in this case, as depicted in FIG. 5, the cutting edge 48 may be deformed such that the tip portion 48b forms a predetermined angle with respect to the base end portion 48a, and the workpiece 11 may be cut along the plane inclined from the planned cutting plane 13a. Specifically, the cutting edge 48 is sometimes deformed such that a side surface 48d of the tip portion 48b forms an angle of approximately 0.5° to 1.0° (in a case in which α is 4°) with respect to the side surface 48c of the base end portion 48a.

The present inventor has been deeply involved in research about this phenomenon. As a result, the present inventor has found that a force F1 in a direction along the c-plane 11h acts on the cutting edge 48 of the cutting blade 44 from the workpiece 11 and deforms the cutting edge 48 when the cutting edge 48 is made to enter the workpiece 11 along a direction inclined with respect to the c-plane 11h or a direction inclined with respect to the perpendicular to the c-plane 11h. Moreover, on the basis of this find, the present inventor has considered that the workpiece 11 can be cut along the planned cutting plane 13a if the force F1 that deforms the cutting edge 48 in such a direction as to bring the angle formed by the planned cutting plane 13a and the tip portion 48b close to 0° can be caused to act on the cutting edge 48 from the workpiece 11.

That is, it becomes possible to cut the workpiece 11 along the planned cutting plane 13a when the force F1 in such an orientation as to bring the angle formed by the planned cutting plane 13a and the tip portion 48b close to 0° acts on the cutting edge 48 from the workpiece 11. Further, the present inventor has completed the present invention group on the basis of these pieces of knowledge.

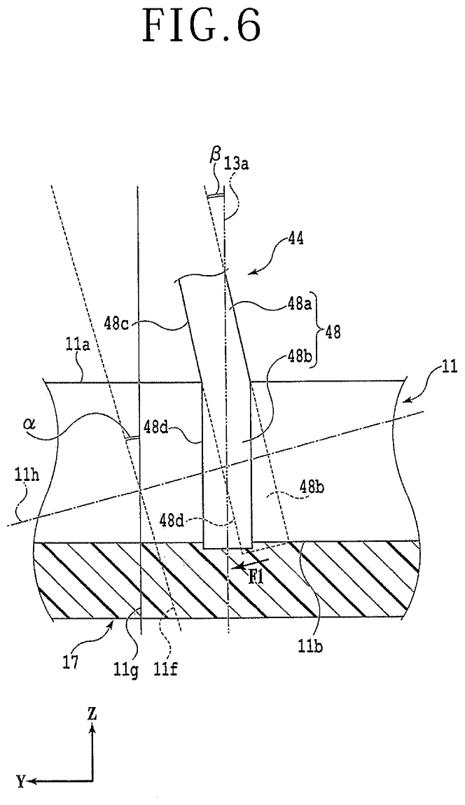

FIG. 6 is a sectional view depicting a state in which the workpiece 11 is cut in the cutting method or the like in the present embodiment. In FIG. 6, hatching and the like of the workpiece 11 are omitted for convenience of description. Moreover, in FIG. 6, a section that is parallel to a YZ-plane and passes through the lowermost point of the cutting edge 48 (cutting blade 44) and the center (not depicted) of rotation is depicted.

As depicted by a dashed line in FIG. 6, in the present embodiment, the cutting blade 44 is used in which the tip portion 48b is substantially not inclined with respect to the base end portion 48a located between the blade base 46 and this tip portion 48b in a state in which the cutting edge 48 is made still without being made to cut into the workpiece 11. That is, the side surface 48c of the base end portion 48a is substantially parallel to the side surface 48d of the tip portion 48b in the state in which the cutting edge 48 has not cut into the workpiece 11.

Further, in the present embodiment, as depicted in FIG. 6, the tip portion 48b cuts into the workpiece 11 in a state in which the base end portion 48a (side surface 48c) is inclined from the planned cutting plane 13a. β as an angle formed by the base end portion 48a (side surface 48c) and the planned cutting plane 13a is typically larger than 0° and smaller than α (angle between the perpendicular 11g and the c-axis 11f), and is preferably, for example, approximately 0.4° to 1.0° in the case in which α is 4°.

Due to this, the force F1 in an orientation like one depicted in FIG. 6 (force F1 in such an orientation as to bring the angle formed by the planned cutting plane 13a and the tip portion 48b close to 0°) acts on the cutting edge 48, and the cutting edge 48 is deformed as depicted by a solid line in FIG. 6. As a result, in the section depicted in FIG. 6, the angle formed by the planned cutting plane 13a and the tip portion 48b (side surface 48d) becomes sufficiently small, and the workpiece 11 is cut along the planned cutting plane 13a.

In order to incline the base end portion 48a (side surface 48c) from the planned cutting plane 13a, in the present embodiment, the spindle 42 is inclined with respect to the Y-axis in the YZ-plane. Specifically, the cutting unit 38 is inclined with respect to the Z-axis moving plate 32 such that a center line of the spindle 42 forms the angle of β with respect to the Y-axis in the YZ-plane. It is preferable for the cutting apparatus 2 to include an inclination adjustment mechanism in order to facilitate adjustment of the inclination of the cutting unit 38 with respect to the Z-axis moving plate 32.

In association with the above-described deformation of the cutting edge 48, the position of the tip portion 48b relative to the workpiece 11 is shifted along the Y-axis. Thus, it is desirable to make the cutting edge 48 cut into the workpiece 11 at a position set in consideration of this shift. In other words, it is desirable that the position of the cutting blade 44 relative to the chuck table 12 be adjusted in consideration of the shift accompanying the deformation of the cutting edge 48. The shift accompanying the deformation of the cutting edge 48 is, for example, approximately 3 μm to 20 μm along the Y-axis in the case in which α is 4°.

Incidentally, immediately after the cutting edge 48 cuts into the workpiece 11, the cutting edge 48 is not sufficiently deformed due to the force F1 and the workpiece 11 cannot be cut along the planned cutting plane 13a in some cases. On the other hand, in a case of cutting the workpiece 11 under the above-described condition, at a stage where the cutting edge 48 has reached a region separate inward by approximately 3 mm from the outer circumferential edge of the workpiece 11, the cutting edge 48 is sufficiently deformed, and the workpiece 11 can be cut along the planned cutting plane 13a.

Thus, in a case of splitting the workpiece 11 by the cutting method in the present embodiment to manufacture chips including the device 15, that is, in the manufacturing method for a chip in the present embodiment, it is desirable to employ an inside region separate by 3 mm or longer from the outer circumferential edge of the workpiece 11 as a device region in which the devices 15 are formed. Due to this, a shape required for the chips including the device 15 can be realized more surely.

As described above, in the cutting method or the like according to the present embodiment, the tip portion 48b is made to cut into the workpiece 11 in the state in which the force F1 in such an orientation as to bring the angle formed by the planned cutting plane 13a and the tip portion 48b close to 0° acts on the cutting edge 48 from the workpiece 11 when the tip portion 48b is made to cut into the workpiece 11. Thus, even with the workpiece 11 including the crystal structure of the hexagonal system (or trigonal system) having the c-axis 11f inclined with respect to the perpendicular 11g to the first surface 11a, it becomes possible to cut the workpiece 11 along the planned cutting plane 13a perpendicular to the first surface 11a.

The present invention is not limited to the description of the above-described embodiment and can be carried out with various changes. For example, in the above-described embodiment, the cutting blade 44 is used in which the tip portion 48b is substantially not inclined with respect to the base end portion 48a in the state in which the cutting edge 48 is made still without being made to cut into the workpiece 11. However, the cutting blade 44 may be configured such that the tip portion 48b is inclined with respect to the base end portion 48a.

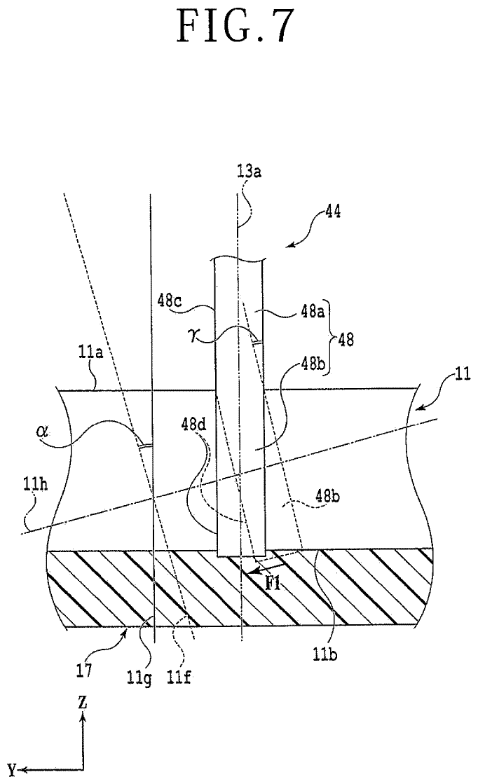

FIG. 7 is a sectional view depicting a state in which the workpiece 11 is cut in a cutting method or the like according to a first modification. In FIG. 7, hatching and the like of the workpiece 11 are omitted for convenience of description. Moreover, in FIG. 7, a section that is parallel to a YZ-plane and passes through the lowermost point of the cutting edge 48 (cutting blade 44) and the center (not depicted) of rotation is depicted.

As depicted by a dashed line in FIG. 7, in the present modification, the cutting blade 44 is used in which the tip portion 48b is inclined with respect to the base end portion 48a located between the blade base 46 and this tip portion 48b in a state in which the cutting edge 48 is made still without being made to cut into the workpiece 11. That is, the side surface 48c of the base end portion 48a is inclined with respect to the side surface 48d of the tip portion 48b in the state in which the cutting edge 48 has not cut into the workpiece 11.

γ as an angle formed by the base end portion 48a (side surface 48c) and the tip portion 48b (side surface 48d) is typically larger than 0° and smaller than α (angle between the perpendicular 11g and the c-axis 11f), and is preferably, for example, approximately 0.4° to 1.0° in the case in which α is 4°. Further, in the present modification, as depicted in FIG. 7, the tip portion 48b cuts into the workpiece 11 in a state in which the base end portion 48a (side surface 48c) is not inclined from the planned cutting plane 13a.

Due to this, the force F1 in an orientation like one depicted in FIG. 7 (force F1 in such an orientation as to bring the angle formed by the planned cutting plane 13a and the tip portion 48b close to 0°) acts on the cutting edge 48, and the cutting edge 48 is deformed as depicted by a solid line in FIG. 7. As a result, in the section depicted in FIG. 7, the angle formed by the planned cutting plane 13a and the tip portion 48b (side surface 48d) becomes sufficiently small, and the workpiece 11 is cut along the planned cutting plane 13a. Details of the others are similar to those in the above-described embodiment.

Also in the cutting method or the like according to the present modification, the tip portion 48b is made to cut into the workpiece 11 in the state in which the force F1 in such an orientation as to bring the angle formed by the planned cutting plane 13a and the tip portion 48b close to 0° acts on the cutting edge 48 from the workpiece 11 when the tip portion 48b is made to cut into the workpiece 11. Thus, even with the workpiece 11 including the crystal structure of the hexagonal system (or trigonal system) having the c-axis 11f inclined with respect to the perpendicular 11g to the first surface 11a, it becomes possible to cut the workpiece 11 along the planned cutting plane 13a perpendicular to the first surface 11a.

In the present modification, the tip portion 48b is made to cut into the workpiece 11 in the state in which the base end portion 48a is not inclined from the planned cutting plane 13a. However, the base end portion 48a may be inclined from the planned cutting plane 13a. That is, the cutting blade 44 according to the present modification, in which the tip portion 48b is inclined with respect to the base end portion 48a, may be appropriately combined with the method according to the embodiment, in which the spindle 42 is inclined with respect to the Y-axis.

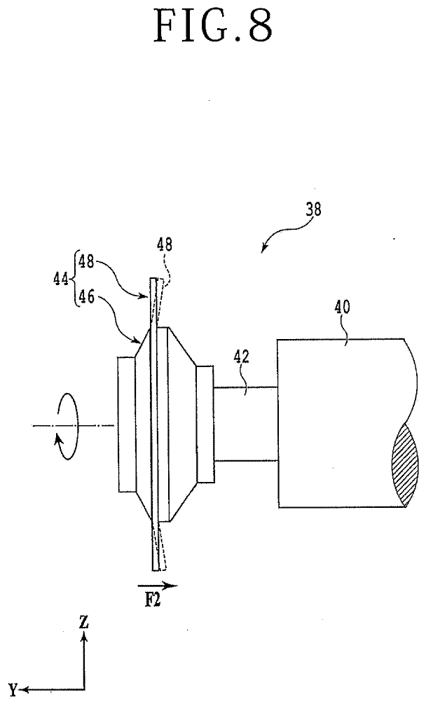

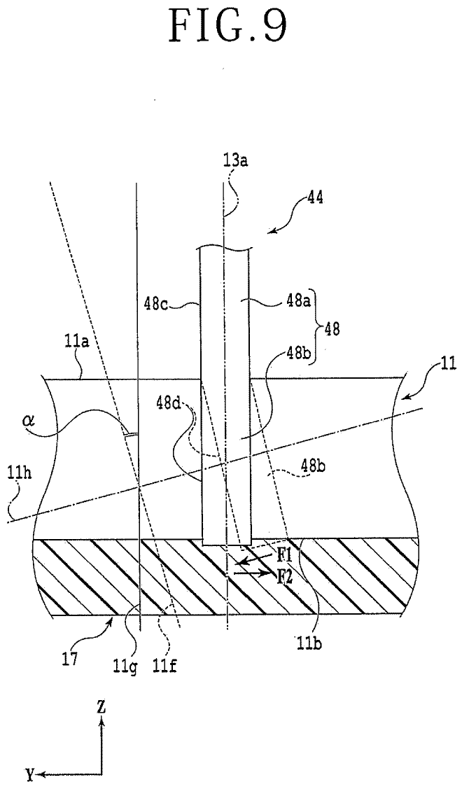

FIG. 8 is a front view depicting a state in which the cutting blade 44 used in a cutting method or the like according to a second modification rotates. FIG. 9 is a sectional view depicting a state in which the workpiece 11 is cut in the cutting method or the like according to the second modification. In FIG. 9, hatching and the like of the workpiece 11 are omitted for convenience of description. Moreover, in FIG. 9, a section that is parallel to a YZ-plane and passes through the lowermost point of the cutting edge 48 (cutting blade 44) and the center (not depicted) of rotation is depicted.

This second modification uses the cutting blade 44 configured such that, as depicted in FIG. 8, when the cutting edge 48 is rotated without being made to cut into the workpiece 11, the cutting edge 48 is deformed due to a force F2 generated in association with this rotation. Specifically, the cutting blade 44 used in the second modification is configured such that, as depicted by a solid line in FIG. 8, the tip portion 48b is substantially not inclined with respect to the base end portion 48a in a state in which the cutting edge 48 is made still without being made to cut into the workpiece 11 (state in which the cutting edge 48 is not rotating).

Further, the cutting blade 44 used in the second modification is configured such that, as depicted by a dashed line in FIG. 8, in a state in which the cutting edge 48 is rotated without being made to cut into the workpiece 11, the tip portion 48b is inclined with respect to the base end portion 48a of the cutting edge 48 due to the force F2 generated in association with this rotation of the cutting edge 48 (cutting blade 44). Asymmetric expansion (deformation) of the blade base 46 due to a centrifugal force is conceivable as one of causes of such deformation of the cutting edge 48 accompanying the rotation of the cutting edge 48 (cutting blade 44).

Moreover, in this second modification, as depicted in FIG. 9, the tip portion 48b cuts into the workpiece 11 in a state in which adjustment has been executed such that part or all of the force F1 that acts on the cutting edge 48 from the workpiece 11 and the force F2 generated in association with the rotation are in such orientations as to cancel out each other. More specifically, the orientation of the workpiece 11 (chuck table 12) relative to the cutting blade 44 (spindle 42) is adjusted such that part or all of the force F1 and the force F2 are in such orientations as to cancel out each other.

Due to this, the tip portion 48b deformed to be inclined with respect to the base end portion 48a due to the force F2 generated in association with the rotation as depicted by a dashed line in FIG. 9 is deformed in an opposite orientation due to the force F1 as depicted by a solid line in FIG. 9. Then, the angle formed by the planned cutting plane 13a and the tip portion 48b comes close to 0°.

In other words, part or all of the force F1 and the force F2 cancel out each other, and the angle formed by the planned cutting plane 13a and the tip portion 48b (side surface 48d) becomes sufficiently small. As a result, the workpiece 11 is cut along the planned cutting plane 13a. Details of the others are similar to those in the above-described embodiment.

Also in the cutting method or the like according to the present modification, the tip portion 48b is made to cut into the workpiece 11 in the state in which the force F1 in such an orientation as to bring the angle formed by the planned cutting plane 13a and the tip portion 48b close to 0° acts on the cutting edge 48 from the workpiece 11 when the tip portion 48b is made to cut into the workpiece 11. Thus, even with the workpiece 11 including the crystal structure of the hexagonal system (or trigonal system) having the c-axis 11f inclined with respect to the perpendicular 11g to the first surface 11a, it becomes possible to cut the workpiece 11 along the planned cutting plane 13a perpendicular to the first surface 11a.

Incidentally, the force F2 used in the second modification is sometimes generated also in the cutting method or the like according to the above-described embodiment or the first modification. In this case, also in the cutting method or the like according to the embodiment or the first modification, it is desirable to adjust, in consideration of the force F2, β as the angle formed by the spindle 42 with respect to the Y-axis or γ as the angle formed by the base end portion 48a and the tip portion 48b.

In the above-described embodiment and modifications, the workpiece 11 is split by making the cutting edge 48 cut into the workpiece 11 such that the height of the lowermost point of the cutting edge 48 is lower than the height of the second surface 11b of the workpiece 11, and chips are manufactured as a result thereof. However, the cutting method of the present invention can be applied also to a case in which the workpiece 11 is not split. For example, a groove may be formed in the workpiece 11 by making the cutting edge 48 cut into the workpiece 11 such that the height of the lowermost point of the cutting edge 48 is higher than the height of the second surface 11b of the workpiece 11.

Besides, structures, methods, and the like according to the above-described embodiment and modifications can be carried out with appropriate changes without departing from the scope of the object of the present invention.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A cutting method for cutting a workpiece, the cutting method comprising:
holding the workpiece including a crystal structure having a c-axis inclined with respect to a perpendicular to a surface and a c-plane perpendicular to the c-axis; and
cutting the workpiece along a planned cutting plane that is perpendicular to the surface and is inclined with respect to the c-plane by rotating a cutting blade having an annular cutting edge and making a tip portion of the cutting edge cut into the workpiece, wherein,
in the cutting the workpiece, the tip portion is made to cut into the workpiece in a state in which a force in such an orientation as to bring an angle formed by the planned cutting plane and the tip portion close to 0° acts on the cutting edge from the workpiece when the tip portion is made to cut into the workpiece.

2. The cutting method according to claim 1, wherein
the cutting blade is configured such that the tip portion is not inclined with respect to a base end portion of the cutting edge on a side opposite to the tip portion in a state in which the cutting edge is made still without being made to cut into the workpiece, and,
in the cutting the workpiece, the tip portion is made to cut into the workpiece in a state in which the base end portion is inclined from the planned cutting plane.

3. The cutting method according to claim 2, wherein,
in the cutting the workpiece, the base end portion is inclined from the planned cutting plane such that the base end portion forms an angle that is larger than 0° and is smaller than an angle between the perpendicular and the c-axis with respect to the planned cutting plane.

4. The cutting method according to claim 1, wherein
the cutting blade is configured such that the tip portion is inclined with respect to a base end portion of the cutting edge on a side opposite to the tip portion in a state in which the cutting edge is made still without being made to cut into the workpiece.

5. The cutting method according to claim 4, wherein
the cutting blade is configured such that the tip portion forms an angle that is larger than 0° and is smaller than an angle between the perpendicular and the c-axis with respect to the base end portion in a state in which the cutting edge is made still without being made to cut into the workpiece.

6. The cutting method according to claim 1, wherein
the cutting blade is configured such that the tip portion is not inclined with respect to a base end portion of the cutting edge on a side opposite to the tip portion in a state in which the cutting edge is made still without being made to cut into the workpiece and the tip portion is inclined with respect to the base end portion due to a force generated in association with rotation of the cutting edge in a state in which the cutting edge is rotated without being made to cut into the workpiece, and,
in the cutting the workpiece, the tip portion is made to cut into the workpiece in a state in which adjustment has been executed such that at least part of the force that acts on the cutting edge from the workpiece and the force generated in association with the rotation of the cutting edge are in such orientations as to cancel out each other.

7. A manufacturing method for a chip in which a workpiece is split to manufacture the chip, the manufacturing method comprising:
holding the workpiece including a crystal structure having a c-axis inclined with respect to a perpendicular to a surface and a c-plane perpendicular to the c-axis; and
cutting the workpiece along a planned cutting plane that is perpendicular to the surface and is inclined with respect to the c-plane by rotating a cutting blade having an annular cutting edge and making a tip portion of the cutting edge cut into the workpiece, wherein,
in the cutting the workpiece, the workpiece is split along the planned cutting plane to manufacture the chip by making the tip portion cut into the workpiece in a state in which a force in such an orientation as to bring an angle formed by the planned cutting plane and the tip portion close to 0° acts on the cutting edge from the workpiece when the tip portion is made to cut into the workpiece.

8. The manufacturing method for a chip according to claim 7, wherein
the cutting blade is configured such that the tip portion is not inclined with respect to a base end portion of the cutting edge on a side opposite to the tip portion in a state in which the cutting edge is made still without being made to cut into the workpiece, and,
in the cutting the workpiece, the tip portion is made to cut into the workpiece in a state in which the base end portion is inclined from the planned cutting plane.

9. The manufacturing method for a chip according to claim 8, wherein,
in the cutting the workpiece, the base end portion is inclined from the planned cutting plane such that the base end portion forms an angle that is larger than 0° and is smaller than an angle between the perpendicular and the c-axis with respect to the planned cutting plane.

10. The manufacturing method for a chip according to claim 7, wherein
the cutting blade is configured such that the tip portion is inclined with respect to a base end portion of the cutting edge on a side opposite to the tip portion in a state in which the cutting edge is made still without being made to cut into the workpiece.

11. The manufacturing method for a chip according to claim 10, wherein
the cutting blade is configured such that the tip portion forms an angle that is larger than 0° and is smaller than an angle between the perpendicular and the c-axis with respect to the base end portion in a state in which the cutting edge is made still without being made to cut into the workpiece.

12. The manufacturing method for a chip according to claim 7, wherein
the cutting blade is configured such that the tip portion is not inclined with respect to a base end portion of the cutting edge on a side opposite to the tip portion in a state in which the cutting edge is made still without being made to cut into the workpiece and the tip portion is inclined with respect to the base end portion due to a force generated in association with rotation of the cutting edge in a state in which the cutting edge is rotated without being made to cut into the workpiece, and,
in the cutting the workpiece, the tip portion is made to cut into the workpiece in a state in which adjustment has been executed such that at least part of the force that acts on the cutting edge from the workpiece and the force generated in association with the rotation of the cutting edge are in such orientations as to cancel out each other.
